(19) United States
(12) Patent Application Publication
(10) Pub. No.: US 2024/0376344 A1
(43) Pub. Date: Nov. 14, 2024

(54) OXIDE COATINGS WITH ADJUSTABLE ION-PERMEATION AS OPTICAL AND PROTECTIVE COATINGS AND METHODS OF MAKING THE SAME

(71) Applicant: CORNING INCORPORATED, CORNING, NY (US)

(72) Inventors: Theresa Chang, Painted Post, NY (US); Albert Joseph Fahey, Corning, NY (US); Ying Wei, Painted Post, NY (US); Shu Yuan, Horseheads, NY (US)

(21) Appl. No.: 18/696,536

(22) PCT Filed: Oct. 7, 2022
(86) PCT No.: PCT/US2022/046049

§ 371 Date: Mar. 28, 2024

Related U.S. Application Data
(60) Provisional application No. 63/253,312, filed on Oct. 7, 2021.

(51) Int. Cl. C09D 183/04; C03C 17/30; C08G 77/04; C09D 5/00; C09D 5/16

(52) U.S. Cl. CPC C09D 183/04; C03C 17/30; C08G 77/045; C09D 5/006; C09D 5/1675; C03C 2217/732; C03C 2218/32

(57) ABSTRACT

A method of manufacturing an article includes depositing a solution on a glass, glass-ceramic, or ceramic substrate, the solution having a polyhedral oligomeric silsesquioxane with the formula (RSiO_{3/2})ₙ, where R is a hydrogen or an organic moiety; curing the solution to form an anti-reflective coating; and plasma treating the anti-reflective coating to form defects in the anti-reflective coating. An article includes a glass, glass-ceramic, or ceramic substrate having a primary surface; a plasma-treated anti-reflective coating disposed over the primary surface that has at least one layer, the at least one layer having a polyhedral oligomeric silsesquioxane with the formula (RSiO_{3/2})ₙ, where R is a hydrogen or an organic moiety; and an easy-to-clean (ETC) coating disposed over the plasma-treated anti-reflective coating, the ETC coating having a fluorinated material and a physical thickness of about 1 nm to about 20 nm.

### CROSS REFERENCE TO RELATED APPLICATIONS

This application claims the benefit of priority under 35 U.S.C. § 119 of U.S. Provisional Application Ser. No. 63/253,312 filed on Oct. 7, 2021 the content of which is relied upon and incorporated herein by reference in its entirety.

### FIELD

The present disclosure generally relates to oxide coatings with adjustable ion permeation as optical and protective coatings and methods of making the same.

### BACKGROUND

Glass, glass-ceramic, and ceramic materials are prevalent in various displays and display devices of many consumer electronic products. For example, chemically strengthened glass is favored for many touch-screen products, including cell phones, music players, e-book readers, notepads, tablets, laptop computers, automatic teller machines, and other similar devices. Many of these glass, glass-ceramic, and ceramic materials are also employed in displays and display devices of consumer electronic products that do not have touch-screen capability, but are prone to direct human contact, including desktop computers, laptop computers, elevator screens, equipment displays, and others.

The glass, glass-ceramic, and ceramic materials are often treated to provide desired aesthetic and functionality characteristics based on the end-use application of the material. For example, anti-reflective, anti-glare, and anti-fingerprint treatments are common treatments used on materials used in touch-screen products. For example, anti-reflective coatings can be utilized to reduce the effect of light reflected by a display on the clarity and/or visibility of the display. Conventional anti-reflective coatings can consist of single layer anti-reflective coatings or multi-layer anti-reflective coatings having different refractive indices to create destructive interference to reduce light reflected by the display. Typically, a single layer anti-reflective coating is optimized at a single wavelength, usually in the middle of the visible region of the electromagnetic spectrum (about 550 nm). Multi-layer anti-reflective coatings can be more effective over a range of wavelengths, such as the visible region of the electromagnetic spectrum (about 400 nm to 700 nm).

Multi-layer anti-reflective coatings are typically produced using multiple vacuum coating, annealing, and/or sintering steps, which can limit the use of multi-layer anti-reflective coatings to small area applications, such as small area laser, electronics, and optics applications. The costs associated with large-area vacuum coating systems can limit the use of multi-layer anti-reflective coatings in applications where it is desirable to produce coatings having a larger area. In contrast, single layer anti-reflective coatings can be deposited using low cost liquid deposition techniques, such as spray coating and dip coating. For example, MgF₂, SiO₂, and CaF₂, are conventional single layer anti-reflective coating materials that can be deposited using spray or dip coating techniques. However, the material properties and porosity that is typically achieved when forming coatings with these types of materials using non-vacuum, liquid-based deposition techniques often results in an anti-reflective coating that does not have the desired level of durability.

In view of these considerations, there is a need for anti-reflective coatings that can be formed as a single layer anti-reflective coating or multi-layer anti-reflective coating stack having a desired level of durability. There is further a need for such anti-reflective coatings that can be formed using liquid-based, non-vacuum deposition techniques.

### SUMMARY

In embodiments, a method of manufacturing an article comprises depositing a solution on a glass, glass-ceramic, or ceramic substrate, the solution comprising a polyhedral oligomeric silsesquioxane having the formula (RSiO_{3/2})ₙ, where R is a hydrogen or an organic moiety; curing the solution to form an anti-reflective coating; and plasma treating the anti-reflective coating to form defects in the anti-reflective coating.

In aspects, which are combinable with any of the other aspects or embodiments, the curing step comprises one of thermal curing or electron-beam curing. In aspects, which are combinable with any of the other aspects or embodiments, the curing step comprises thermally curing the solution at a temperature of from 400° C. to 800° C. In aspects, which are combinable with any of the other aspects or embodiments, the solution comprises a primary, secondary, or tertiary amine base catalyst. In aspects, which are combinable with any of the other aspects or embodiments, the catalyst comprises at least one of hexylamine, aminopropyl trialkoxysilane, alkylamines, acetone oxime, cyclohexylamine, or combinations thereof. In aspects, which are combinable with any of the other aspects or embodiments, the curing step comprises thermally curing the solution at a temperature of from 80° C. to 250° C.

In aspects, which are combinable with any of the other aspects or embodiments, the solution comprises from about 0.2 wt. % to about 15 wt. % of the polyhedral oligomeric silsesquioxane. In aspects, which are combinable with any of the other aspects or embodiments, the method further comprises depositing an easy-to-clean (ETC) coating over the anti-reflective coating, the ETC coating comprising a fluorinated material and a thickness of about 1 nm to about 20 nm. In aspects, which are combinable with any of the other aspects or embodiments, the ETC coating comprises an average contact angle with water of at least about 100 degrees after being subjected to 200,000 cycles of a cheese cloth abrasion test. In aspects, which are combinable with any of the other aspects or embodiments, the anti-reflective coating has a thickness of from about 10 nm to about 150 nm. In aspects, which are combinable with any of the other aspects or embodiments, the plasma-treated anti-reflective coating exhibits at least a bacterial log 3 (avg.) kill as measured by Japanese Industrial Standard Z2801. In aspects, which are combinable with any of the other aspects or embodiments, the step of plasma treating comprises an air plasma treatment or an O₂ plasma treatment.

In embodiments, an article comprises a glass, glass-ceramic, or ceramic substrate comprising a primary surface; a plasma-treated anti-reflective coating disposed over the primary surface that comprises at least one layer, the at least one layer comprising a polyhedral oligomeric silsesquioxane having the formula (RSiO_{3/2})ₙ, where R is a hydrogen or an organic moiety; and an easy-to-clean (ETC) coating disposed over the plasma-treated anti-reflective coating, the ETC coating comprising a fluorinated material and a physical thickness of about 1 nm to about 20 nm.

In aspects, which are combinable with any of the other aspects or embodiments, the ETC coating comprises an average contact angle with water of at least about 100 degrees after being subjected to 200,000 cycles of a cheese cloth abrasion test. In aspects, which are combinable with any of the other aspects or embodiments, the plasma-treated anti-reflective coating has a physical thickness of from about 10 nm to about 150 nm. In aspects, which are combinable with any of the other aspects or embodiments, the plasma-treated anti-reflective coating exhibits at least a bacterial log 3 (avg.) kill as measured by Japanese Industrial Standard Z2801. In aspects, which are combinable with any of the other aspects or embodiments, the glass, glass-ceramic, or ceramic substrate comprises Ag ions.

These and other aspects, objects, and features of the present disclosure will be understood and appreciated by those skilled in the art upon studying the following specification, claims, and appended drawings.

### BRIEF DESCRIPTION OF THE DRAWINGS

The disclosure will become more fully understood from the following detailed description, taken in conjunction with the accompanying figures, in which:

FIG. 1 is a cross-sectional, schematic view of an article comprising a glass, glass-ceramic, or ceramic substrate with an anti-reflective coating and an ETC coating, according to embodiments of the present disclosure.

FIG. 2 is a flow chart illustrating a method of forming an anti-reflective coating on a glass, glass-ceramic, or ceramic substrate, according to embodiments of the present disclosure.

FIG. 3 is a plot of refractive index (as measured at 550 nm) as a function of curing temperature for a film containing hydrogen silsesquioxane (HSQ) at different film thicknesses for use in forming an anti-reflective coating, according to embodiments of the present disclosure.

FIGS. 4A-4C are time-of-flight secondary-ion mass spectrometry (ToF-SIMS) depth profiles of AMGG samples without a HSQ coating (FIG. 4A), AMGG samples with a non-plasma-treated HSQ coating (FIG. 4B), and AMGG samples with a plasma-treated HSQ coating (FIG. 4C), according to embodiments of the present disclosure.

FIG. 5 is data from an AGS Standard cheesecloth abrasion test for AMGG samples with a plasma-treated HSQ coating, according to embodiments of the present disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The term “formed from” can mean one or more of comprises, consists essentially of, or consists of. For example, a component that is formed from a particular material can comprise the particular material, consist essentially of the particular material, or consist of the particular material.

As also used herein, the terms “article,” “glass-article,” “ceramic-article,” “glass-ceramics,” “glass elements,” “glass-ceramic article” and “glass-ceramic articles” may be used interchangeably, and in their broadest sense, to include any object made wholly or partly of glass and/or glass-ceramic material.

The term “disposed” is used herein to refer to a layer or sub-layer that is coated, deposited, formed, or otherwise provided onto a surface. The term disposed can include layers/sub-layers provided in direct contact with adjacent layers/sub-layers or layers/sub-layers separated by intervening material which may or may not form a layer.

Unless stated otherwise, samples described herein were optically characterized using a PerkinElmer, Inc. Lambda 950 UV/Vis/NIR spectrophotometer system. The system was periodically calibrated according to ASTM recommended procedures using absolute physical standards, or standards traceable to the National Institute of Standards and Technology (NIST). Unless otherwise specified, the total, specular, and average reflectance values reported herein are first-surface reflectance values, i.e., the measured sample included a substrate having a coating on only one side of the substrate.

As used herein, the first-surface reflected color shift ΔCⱼ* of a sample is calculated for each angle of incidence (AOI), j, according to formula (I):

$$Δ C {*}_{j} = \sqrt{( {( a {*}_{j} - a {*}_{0} )}^{2} + {( b {*}_{j} - b {*}_{0} )}^{2} )} \qquad ( I )$$

where a₀* and b₀* are the CIE LAB a* and b* values at an AOI of 0 degrees respectively, and aⱼ* and bⱼ* are the CIE LAB a* and b* values at an AOI of j degrees. Unless otherwise stated, the color shift was measured and calculated using a D65 illuminant. The first-surface reflectance and reflected color was measured by the coupling the back surface of a sample to a black glass absorber using a refractive index matching oil to remove the effect of back-surface reflectance. The measured reflectance and reflected color values include the glass substrate, the SSQ layer, and the ETC layer, unless otherwise noted.

As used herein, the “Steel Wool Abrasion Test” is a test employed to determine the durability of an easy-to-clean (ETC) coating deposited on a substrate of interest. The Steel Wool Abrasion Test data reported herein was determined as follows, unless otherwise stated. Steel wool (Bonstar #0000) was first cut into strips (25 mm×12 mm) and placed on a sheet of aluminum foil to bake in an oven for 2 hours at 100° C. The steel wool strip was fitted to an attachment (10 mm×10 mm) of an abrader (5750, Taber Industries) using a zip tie. Weights totaling 720 g were added to the Taber arm to result in a total applied load of 1 kg. The stroke length was set at 25 mm and the speed was set to 40 cycles per minute. The area to be abraded was marked onto the back of the sample for tracking. Typically, each sample fit two tracks, one track was run for 2000 cycles and the second track was run for 3000 cycles. Once the abrasion test was complete the sample was characterized using static water contact angles. Without being bound by theory, a smaller change in the average contact angle over time is indicative of an increase in durability of the measured coating. A high contact angle (e.g., above 80 degrees, above 90 degrees, or even 100 degrees) is indicative of the presence of an ETC layer. Decreases in the contact angle below 70 degrees has been shown to correlate with a loss of the ETC layer.

As used herein, the “cheesecloth abrasion test” is a test employed to determine the durability of an easy-to-clean (ETC) coating deposited on a substrate of interest. The abrasion resistance is tested using a Linear Taber Abrader (Model 5750; Taber Industries, North Tonawanda, NY) with a cylindrical tip with a radius of 2 cm, affixed with 4 layers of cheesecloth wrap (Crockmeter Squares for American Standards, 200877; SDL Atlas USA, Rock Hill, SC) and with a constant load of 750 g. The pathlength of each swipe is 15 mm, with each cycle comprising a forward and backward swipe and returning the tip to its original position before proceeding with the next cycle. The speed was 30 cycles per minute, testing under ambient temperature (23° C.).

Embodiments of the present disclosure relate to articles and methods of manufacturing such an article that include a glass, glass-ceramic, or ceramic substrate having a primary surface and an anti-reflective coating including a layer containing a silsesquioxane material, such as a polyhedral oligomeric silsesquioxane, having the formula (RSiO3/2)n, where R is a hydrogen or an organic moiety, disposed over the primary surface. The anti-reflective coating can exhibit a first-surface reflected color shift (ΔCj*) of 15 or less at each angle of incidence (AOI), j, from 8 to 60 degrees, as relative to normal incidence at 0 degrees. The silsesquioxane-based anti-reflective coatings of the present disclosure can have a suitable abrasion resistance, as characterized by the abrasion resistance of an easy-to-clean (ETC) layer deposited over the silsesquioxane-based anti-reflective coating. In embodiments, the ETC layer may contain a silane or a fluorosilane material that is hydrophobic and/or exhibits a water angle greater than 90 degrees.

The articles disclosed herein may be incorporated into a device article such as a device article with a display (or display device articles), non-limiting examples of which include consumer electronics (including mobile phones, tablets, computers, navigation systems, wearable devices, such as watches, and the like), architectural device articles, transportation device articles (e.g., automotive, trains, aircraft, sea craft, etc.), and appliance device articles.

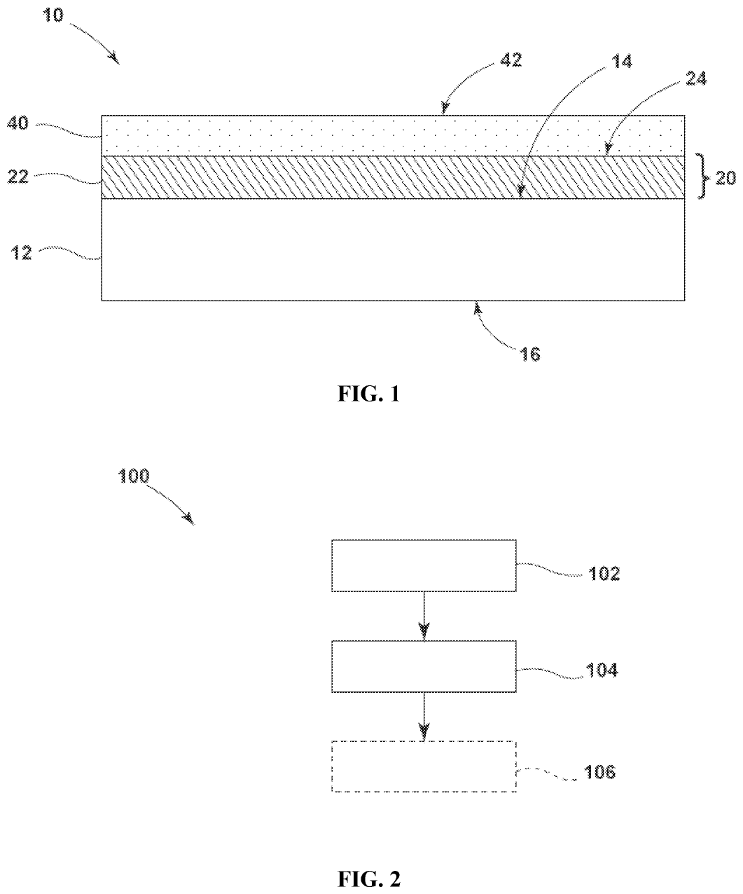

Referring to FIG. 1, an article 10 is illustrated according to an aspect of the present disclosure. The article 10 can include a substrate 12 that includes a glass, glass-ceramic, or ceramic composition. The article 10 can include a pair of opposing primary surfaces, first primary surface 14 and second primary surface 16. An optical film 20 is disposed on at least one of the first primary surface 14 and second primary surface 16. While the optical film 20 is illustrated as being disposed only on the first primary surface 14, aspects of the present disclosure include disposing the optical film 20 on the second primary surface 16 or both the first primary surface 14 and second primary surface 16. The optical film 20 includes at least one anti-reflective coating 22 containing a silsesquioxane having the formula (RSiO3/2)n, where R is a hydrogen or an organic moiety. The at least one anti-reflective coating 22 can define an outer surface 24 of the optical film 20. An easy-to-clean (ETC) coating 40 can be disposed directly on the outer surface 24 of the anti-reflective coating 22. The ETC coating 40 includes an outer surface 42 that may define a coated surface of the article 10. Without being bound by theory, it is believed that preferential bond formation between the silsesquioxane layer and the ETC layer may promote a high durability of the ETC layer and the overall coating structure, as measured according to a frictional wear test, such as the Steel Wool Test described herein, for example.

The optical film 20 includes the at least one anti-reflective coating 22 and in embodiments may include multiple anti-reflective coatings forming an anti-reflective stack. Optionally, the optical film 20 can include one or more additional layers/sub-layers and/or coatings adapted to provide the article 10 with a desired optical property. Additional non-limiting examples of components of the optical film 20 include anti-glare coatings, scratch-resistant coatings, impedance matching layers, and combinations thereof. In embodiments, the optical film 20 can include one or more additional layers/sub-layers and/or coatings disposed between the at least one anti-reflective coating 22 and the first primary surface 14 of the substrate 12. In embodiments, the anti-reflective coating 22 can be an anti-reflective stack that includes both high refractive index (n) material layers (n>1.6) and low refractive index material layers (n<1.55). Examples of suitable high refractive index materials can contain TiO₂, Nb₂O₅, Ta₂O₅, HfO₂, Al₂O₃, Si₃N₄, SiNₓ, SiOₓN_{y}, AlN, AlOₓN_{y}, SiAlᵤOₓN_{y}, and mixtures thereof. Examples of suitable low refractive index materials can contain SiO₂, MgF₂, SiOₓN_{y}, siloxanes, silsesquioxanes, and mixtures thereof. In such stacks, the outermost layer will generally be an ETC layer as described elsewhere herein, and the 2nd layer adjacent to the outermost ETC layer will generally be a silsesquioxane-containing layer according to embodiments of the present disclosure. The thickness of each layer may typically lie in the range from about 10 nm to about 150 nm. In embodiments, a lower number of layers may be preferred, e.g. less than 10, less than 6, or less than 5 layers, such as for practical and/or cost concerns. While a simple 2-layer system (SSQ and ETC only) may be preferred for cost considerations, a multilayer system with 3 or more layers is contemplated for applications requiring specific optical performance levels, such as lower reflectance over a broad wavelength band. For example, a multilayer system with 3 or more layers may be utilized when optical performance requires less than 1.0% reflectance as an average from 450 nm to 650 nm, or for all wavelengths from 450 nm to 650 nm. Thus the exact nature of the optical film 20, i.e., the materials and/or number of layers present, in addition to the SSQ and ETC layers of the present disclosure, can be selected as needed to provide the optical film 20 with the desired optical properties.

In embodiments, the substrate 12 includes a glass composition. The substrate 12, for example, can include a borosilicate glass, an aluminosilicate glass, soda-lime glass, chemically strengthened borosilicate glass, chemically strengthened aluminosilicate glass, or chemically strengthened soda-lime glass. The substrate may have a selected length and width, or diameter, to define its surface area. The substrate may have at least one edge between the first primary surface 14 and second primary surface 16 of the substrate 12 defined by its length and width, or diameter.

In embodiments, the substrate 12 includes a glass-ceramic material having both a glassy phase and a ceramic phase. Illustrative glass-ceramics include those materials where the glass phase is formed from a silicate, borosilicate, aluminosilicate, or boroaluminosilicate, and the ceramic phase is formed from β-spodumene, β-quartz, nepheline, kalsilite, or carnegieite. “Glass-ceramics” include materials produced through controlled crystallization of glass. Examples of suitable glass-ceramics may include Li2O—Al2O3-SiO2 system (i.e., LAS-System) glass-ceramics, MgO—Al2O3-SiO2 system (i.e., MAS-System) glass-ceramics, ZnO×Al2O3×nSiO2 (i.e., ZAS system), and/or glass-ceramics that include a predominant crystal phase including β-quartz solid solution, β-spodumene, cordierite, and lithium disilicate. The glass-ceramic substrates may be strengthened using a chemical strengthening process.

In embodiments, the substrate 12 includes a ceramic material such as inorganic crystalline oxides, nitrides, carbides, oxy nitrides, carbo nitrides, and/or the like. Illustrative ceramics include those materials having an alumina, aluminum titanate, mullite, cordierite, zircon, spinel, perovskite, zirconia, ceria, silicon carbide, silicon nitride, silicon aluminum oxynitride, or zeolite phase.

The substrate 12 can have any suitable thickness based at least in part on the intended application of the article 10. In embodiments, the substrate 12 can have a thickness of from about 10 micrometers (μm) to about 5 millimeters (mm), and any range or sub-ranges therein. For example, the substrate 12 can have a thickness of from about 10 μm to about 5 mm, about 10 μm to about 4 mm, about 10 μm to about 3 mm, about 10 μm to about 2 mm, about 10 μm to about 1 mm, about 10 μm to about 500 μm, about 10 μm to about 250 μm, about 10 μm to about 100 μm, about 100 μm to about 5 mm, about 100 μm to about 4 mm, about 100 μm to about 3 mm, about 100 μm to about 2 mm, about 100 μm to about 1 mm, about 100 μm to about 500 μm, about 100 μm to about 250 μm, about 250 μm to about 5 mm, about 250 μm to about 4 mm, about 250 μm to about 3 mm, about 250 μm to about 2 mm, about 250 μm to about 1 mm, about 250 μm to about 500 μm, about 500 μm to about 5 mm, about 500 μm to about 4 mm, about 500 μm to about 3 mm, about 500 μm to about 2 mm, about 500 μm to about 1 mm, about 1 mm to about 5 mm, about 1 mm to about 4 mm, about 1 mm to about 3 mm, or about 2 mm to about 5 mm.

According to an embodiment of the present disclosure, the anti-reflective coating 22 contains a layer that includes a silsesquioxane material. In embodiments, the anti-reflective coating 22 is formed from a solution containing a silsesquioxane material that is spin-coated onto the desired substrate and subsequently cured. The silsesquioxane material of the anti-reflective coating 22 is represented by the formula [RSiO3/2]n, where R is H or an organic moiety such as an alkyl, aryl, or alkoxyl group. In embodiments, the silsesquioxane material is a polyhedral oligomeric silsesquioxane material (also referred to as POSS). In some examples, the silsesquioxane material can have a cage-like or polymeric structure having Si—O—Si linkages and tetrahedral Si vertices. In some examples, the silsesquioxanes may form 6, 8, 10, or 12 silicon vertices in which each silicon center is bonded to three oxo groups, which in turn connect to other silicon centers. An exemplary silsesquioxane material is hydrogen silsesquioxane (HSQ) in which R is a hydrogen.

The anti-reflective coating 22 can have a physical thickness of about 3 nm to up to several hundreds of nanometers based at least in part on the intended application and/or other components of the article, such as the ETC coating 40. For example, the anti-reflective coating 22 can have a physical thickness of at least 10 nm, at least 15 nm, at least 50 nm, at least 100 nm, at least 500 nm, or at least 1 μm. In embodiments, the anti-reflective coating 22 can have a physical thickness of from about 10 nm to about 150 nm. For example, the anti-reflective coating 22 can have a physical thickness of from about 10 nm to about 150 nm, about 20 nm to about 150 nm, about 50 nm to about 150 nm, about 75 nm to about 150 nm, about 100 nm to about 150 nm, about 125 nm to about 150 nm, about 10 nm to about 125 nm, about 20 nm to about 125 nm, about 50 nm to about 125 nm, about 75 nm to about 125 nm, about 100 nm to about 125 nm, about 10 nm to about 100 nm, about 20 nm to about 100 nm, about 50 nm to about 100 nm, about 75 nm to about 100 nm, about 10 nm to about 75 nm, about 20 nm to about 75 nm, about 50 nm to about 75 nm, about 10 nm to about 50 nm, or about 20 nm to about 50 nm. In embodiments, the anti-reflective coating 22 can have a thickness that is approximately ¼ of the wavelength of the visible light in the material, which typically corresponds to a physical thickness of from about 75 nm to about 125 nm.

In embodiments, the anti-reflective coating 22 is characterized by a refractive index of from about 1.2 to about 1.6, as measured at 550 nm. For example, the anti-reflective coating 22 can have a refractive index of from about 1.2 to about 1.6, about 1.25 to about 1.6, about 1.3 to about 1.6, about 1.35 to about 1.6, about 1.4 to about 1.6, about 1.45 to about 1.6, about 1.5 to about 1.6, about 1.55 to about 1.6, about 1.2 to about 1.55, about 1.25 to about 1.55, about 1.3 to about 1.55, about 1.35 to about 1.55, about 1.37 to about 1.52, about 1.4 to about 1.55, about 1.45 to about 1.55, about 1.2 to about 1.5, about 1.25 to about 1.5, about 1.3 to about 1.5, about 1.35 to about 1.5, about 1.4 to about 1.5, about 1.45 to about 1.5, about 1.2 to about 1.45, about 1.25 to about 1.45, about 1.3 to about 1.45, about 1.35 to about 1.45, about 1.4 to about 1.45, about 1.2 to about 1.4, about 1.25 to about 1.4, about 1.3 to about 1.4, about 1.35 to about 1.4, about 1.2 to about 1.35, about 1.25 to about 1.35, or about 1.3 to about 1.35, as measured at 550 nm. In some examples, the anti-reflective coating can have a refractive index of about 1.2, about 1.25, about 1.3, about 1.325, about 1.363, about 1.368, about 1.383, about 1.35, about 1.37, about 1.4, about 1.45, about 1.5, about 1.52, about 1.55, about 1.6, or any refractive index between these values, as measured at 550 nm.

In embodiments, the anti-reflective coating 22 can be characterized by a first-surface reflectance of less than about 2% for at least one wavelength within the range of 400 nm to 1000 nm. As used herein, the first-surface reflectance includes specular and total reflectance. For example, the anti-reflective coating 22 can be characterized by a first-surface reflectance of less than about 2%, less than about 1.8%, less than about 1.6%, less than about 1.5%, or less than about 1.0% for at least one wavelength within the range of 400 nm to 1000 nm.

In embodiments, the anti-reflective coating 22 can be characterized by an average reflectance of less than about 2%, as measured from 450 nm to 650 nm. For example, the anti-reflective coating 22 can have an average reflectance of less than about 2%, less than about 1.8%, less than about 1.6%, or less than about 1.5%, as measured from 450 nm to 650 nm. The average reflectance values reported herein are measured as described above, unless otherwise stated.

In aspects of the present disclosure, the color of the light reflected by the anti-reflective coating 22 can exhibit little to no change in color when viewed from a range of angles, i.e., can exhibit stability in the color of reflected light when viewed at different angles. The stability of the color of the light reflected by the anti-reflective coating 22 as viewed over a range of angles can be represented by determining a first-surface color shift (ΔCj*), i.e., a change in CIE LAB color ΔC*, at each angle of incidence (AOI) over a range of angles, j, according to formula (I). In embodiments the anti-reflective coating 22 can be characterized by a first-surface reflected color shift (ΔCj*) of 15 or less at each angle of incidence (AOI), j, from 8 to 60 degrees, as relative to normal incidence at 0 degrees according to formula (I). For example, the anti-reflective coating 22 can be characterized by a first-surface reflected color shift (ΔCj*) of 15 or less, 12 or less, 10 or less, 8 or less, 6 or less, 5 or less, 4 or less, or 3 or less at each angle of incidence (AOI), j, from 8 to 60 degrees, as relative to normal incidence at 0 degrees according to formula (I). In embodiments the anti-reflective coating 22 can be characterized by a first-surface reflected color shift (ΔCj*) of 15 or less at each angle of incidence (AOI), j, from 0 to 60 degrees, as relative to normal incidence at 0 degrees according to formula (I). For example, the anti-reflective coating 22 can be characterized by a first-surface reflected color shift (ΔCj*) of 15 or less, 12 or less, 10 or less, 8 or less, 6 or less, 5 or less, 4 or less, or 3 or less at each angle of incidence (AOI), j, from 0 to 60 degrees, as relative to normal incidence at 0 degrees according to formula (I) above.

In embodiments, the anti-reflective coating 22 can be characterized by a porosity of from about 15% to about 30%. For example, the anti-reflective coating 22 can have a porosity of from about 15% to about 30%, about 17% to about 30%, about 19% to about 30%, about 20% to about 30%, about 21% to about 30%, about 22% to about 30%, about 23% to about 30%, about 15% to about 25%, about 17% to about 25%, about 19% to about 25%, about 20% to about 25%, about 21% to about 25%, about 22% to about 25%, about 23% to about 25%, about 15% to about 23%, about 17% to about 23%, about 19% to about 23%, about 20% to about 23%, about 21% to about 23%, about 15% to about 22%, about 17% to about 22%, about 19% to about 22%, about 20% to about 22%, about 15% to about 21%, about 17% to about 21%, about 19% to about 21%, about 15% to about 20%, about 17% to about 20%, about 19% to about 20%, about 15% to about 19%, about 17% to about 19%. In some examples, the anti-reflective coating 22 has a porosity of about 15%, about 17%, about 17.1%, about 19%, about 20%, about 20.2%, about 21%, about 21.3%, about 22%, about 23%, about 24%, about 25%, about 26%, about 27%, about 28%, about 29%, about 29.2%, about 30%, or any porosity between these values.

The optical coating 20 can include a single anti-reflective coating 22 or multiple layers of an anti-reflective coating 22 containing a cured silsesquioxane material according to the embodiments of the present disclosure. In some examples, the optical coating 20 can include multiple anti-reflective coatings 22 that may have the same or different thickness, silsesquioxane material, porosity, and/or refractive index. In some examples, the optical coating 20 can include multiple anti-reflective coatings 22, where each anti-reflective coating 22 is formed using the same or different processing conditions, examples of which include concentration of silsesquioxane material, deposition solvent, curing conditions (e.g., curing temperature and/or time), and/or type and concentration of additives (e.g., pore former). The materials and processing conditions can be selected to provide one or more anti-reflective coatings having the desired optical properties, such as a desired refractive index and/or a reflectance profile having a desired minimum reflectance value, a minimum reflectance centered around a desired wavelength, and/or a desired average reflectance value across a predetermined range of wavelengths.

The easy-to-clean (ETC) coating 40 can be disposed directly on the outer surface 24 of the anti-reflective coating 22. In embodiments, the ETC coating 40 can include any suitable polymer material and/or fluorinated material, examples of which include a fluorinated material with silane moieties, a fluoroether silane, a perfluoropolyether (PFPE) silane, a perfluoroalkylether, and a PFPE oil. According to one aspect, a physical thickness of the ETC coating 40 is from about 1 nm to about 20 nm. In other aspects, the physical thickness of the ETC coating 40 is from about 1 nm to about 20 nm, about 2 nm to about 10 nm, about 3 nm to about 10 nm, about 4 nm to about 10 nm, about 5 nm to about 10 nm, about 1 nm to about 200 nm, about 1 nm to about 100 nm, about 1 nm to about 50 nm, about 2 nm to about 200 nm, about 2 nm to about 100 nm, about 2 nm to about 50 nm, about 5 nm to about 200 nm, about 5 nm to about 100 nm, about 5 nm to about 50 nm, about 1 nm to about 2 nm, about 1 nm to about 3 nm, about 1 nm to about 4 nm, about 1 nm to about 5 nm, about 2 nm to about 3 nm, about 2 nm to about 4 nm, or about 2 nm to about 5 nm. For example, the ETC coating 40 can have a physical thickness of about 1 nm, about 2 nm, about 3 nm, about 4 nm, about 5 nm, about 10 nm, about 15 nm, about 20 nm, about 50 nm, about 100 nm, about 200 nm, or any physical thickness between these values. In some examples, the ETC coating 40 may be a monolayer either vertically or horizontally arranged on the outer surface 24 of the anti-reflective coating 22.

According to embodiments, the ETC coating 40 can be characterized by a durability as determined by the Steel Wool Abrasion Test, as described above. According to an aspect of the present disclosure, the ETC coating 40 can exhibit an average contact angle with water of at least about 80 degrees, at least about 90 degrees, at least about 100 degrees, at least about 105 degrees, or at least about 110 degrees after being subjected to 2000 reciprocating cycles under a load of 1 kg according to a Steel Wool Abrasion Test. In aspects, the ETC coating 40 exhibits an average contact angle with water of at least about 100 degrees, at least about 105 degrees, or at least about 110 degrees after being subjected to 3000 reciprocating cycles under a load of 1 kg according to a Steel Wool Abrasion Test.

Referring to FIG. 2, a method 100 for forming an article according to an embodiment of the present disclosure is illustrated. The method 100 can be used to form an article, such as the article 10 described above with respect to FIG. 1, which includes the anti-reflective coating 22 according to the present disclosure. The method 100 can be used to provide an anti-reflective coating 22 containing a silsesquioxane material and having the desired thickness and optical properties, examples of which include a desired refractive index, first-surface reflectance, average reflectance, and/or first-surface color shift (ΔC0*), as described herein.

The method 100 can include a step 102 of depositing a solution containing a silsesquioxane material onto a sample. With respect to the exemplary embodiment of FIG. 1, the solution can be deposited directly on the substrate 12 or on a component of the optical film 20 that has already been deposited on the substrate 12. The components of the solution deposited at step 102, such as type of silsesquioxane material, concentration of silsesquioxane material, solvent, and optional additives, can be selected to provide an anti-reflective coating 22 upon curing that has the desired thickness and optical properties. For example, In embodiments, the solution deposited at step 102 can include from about 0.2% to about 15%, by weight (wt %), of the silsesquioxane material. In some examples, the solution includes from about 0.2 wt % to about 15 wt %, about 0.5 wt % to about 15 wt %, about 0.75 wt % to about 15 wt %, about 1 wt % to about 15 wt %, about 1 wt % to about 7.5 wt %, about 1.5 wt % to about 7.5 wt %, about 2 wt % to about 7.5 wt %, about 2.5 wt % to about 7.5 wt %, about 7.5 wt % to about 15 wt %, about 8 wt % to about 15 wt %, about 8.5 wt % to about 15 wt %, about 9 wt % to about 15 wt %, about 9.5 wt % to about 15 wt %, about 10 wt % to about 15 wt %, about 5 wt % to about 10 wt %, about 2.5 wt % to about 12.5 wt %, or any sub-range or value provided therein of the silsesquioxane material.

As described above with respect to the substrate 12 of the article 10, the substrate 12 can be a glass, glass-ceramic, or ceramic material. The optional components of the optical film 20 described herein can be provided on the substrate 12 according to any conventional method for depositing such materials, examples of which include physical vapor deposition (“PVD”), electron beam deposition (“e-beam” or “EB”), ion-assisted deposition-EB (“IAD-EB”), laser ablation, vacuum arc deposition, sputtering, plasma enhanced chemical vapor deposition (PECVD).

The solution containing a silsesquioxane material can be deposited in any suitable manner to provide a layer of material having a desired thickness. According to one embodiment, the silsesquioxane material can be deposited using a liquid-based, non-vacuum technique, such as spray coating and spin coating. In an exemplary embodiment, the solution is spin-coated onto the sample. The amount of solution, spin-coat speed, and spin time can be selected to provide a layer of material having the desired thickness.

In embodiments, the solution deposited at step 102 can include a pore former. The pore former can be present as an additive in the solution and/or incorporated into the silsesquioxane material. For example, the pore former can be a small organic molecule that is present in the solution and/or an organic functional group forming at least a portion of the silsesquioxane material. In another example, the pore former can be a macromolecule, such as cyclodextrin or polyethylene oxide, that could impart porosity to the coating upon curing. Without wishing to be limited by any theory, it is believed that organic materials may burn off during curing, which can affect the porosity of the cured coating, and which may also affect the refractive index of the cured coating. For example, HSQ is an example of a silsesquioxane material according to the present disclosure having the formula (RSiO3/2)n, where R is a hydrogen. A POSS having an organic moiety as the R group could impart a different porosity to the cured coating compared to HSQ, which could provide the anti-reflective coating 22 with different optical properties. Additional examples of pore formers can include cationic or anionic surfactants (for example, as further described in Huo, Qisheng, et al. “Generalized synthesis of periodic surfactant/inorganic composite materials.” Nature 368.6469 (1994): 317-321) or block copolymers (for example, as further described in Yang, Peidong, et al. “Generalized syntheses of large-pore mesoporous metal oxides with semicrystalline frameworks.” Nature 396.6707 (1998): 152-155; and Zhao, Dongyuan, et al. “Triblock copolymer syntheses of mesoporous silica with periodic 50 to 300 angstrom pores.” Science 279.5350 (1998): 548-552).

At step 104, the solution deposited at step 102 can be cured to form the anti-reflective coating 22. The curing process can include thermal curing or other curing process techniques, an example of which includes electron-beam curing. In embodiments, the curing conditions at step 104 can include heating the deposited solution at a time and temperature suitable for curing the solution to form the anti-reflective coating 22 having the desired optical properties. For example, the curing at step 104 can include thermally curing the deposited solution by heating the solution to a temperature of from about 400° C. to about 800° C. For example, the curing step 104 can include heating the solution to a temperature of from about 400° C. to about 800° C., about 500° C. to about 800° C., about 600° C. to about 800° C., about 700° C. to about 800° C., about 400° C. to about 700° C., about 500° C. to about 700° C., about 600° C. to about 700° C., about 400° C. to about 600° C., about 500° C. to about 600° C., about 400° C. to about 500° C., or any sub-range or value provided therein.

In embodiments, the solution containing a silsesquioxane material and deposited at step 102 may also include a catalyst to catalyze the silsesquioxane material during curing. The catalyst can facilitate curing the material to a desired degree at a lower temperature than would typically be obtained in the absence of the catalyst. Non-limiting examples of suitable catalysts include hexylamine, aminopropyl trialkoxysilane, alkylamines, acetone oxime, and cyclohexylamine. In embodiments, the catalyst is a suitable primary, secondary, or tertiary amine base. Without wishing to be limited by any theory, it is believed that unhindered primary amine bases may react faster than secondary or tertiary amine bases. In embodiments, the catalyst can be a protected or non-protected primary amine. Hexylamine is an example of a suitable non-protected amine. Acetone oxime is an example of a protected amine. A 1% by volume (% v/v) solution of acetone oxime in pentyl propionate is one example of a catalyst solution. In embodiments, the catalyst can be a protected amine that is activated in the presence of an activator molecule or activated by exposure to UV or thermal energy. With a catalyst included, the curing at step 104 can include thermally curing the deposited solution by heating the solution to a temperature of from about 80° C. to about 250° C. For example, the curing step 104 can include heating the solution to a temperature of from about 80° C. to about 250° C., about 100° C. to about 250° C., about 100° C. to about 225° C., about 120° C. to about 225° C., about 120° C. to about 200° C., about 150° C. to about 200° C., about 80° C. to about 125° C., about 125° C. to about 250° C., or any sub-range or value provided therein.

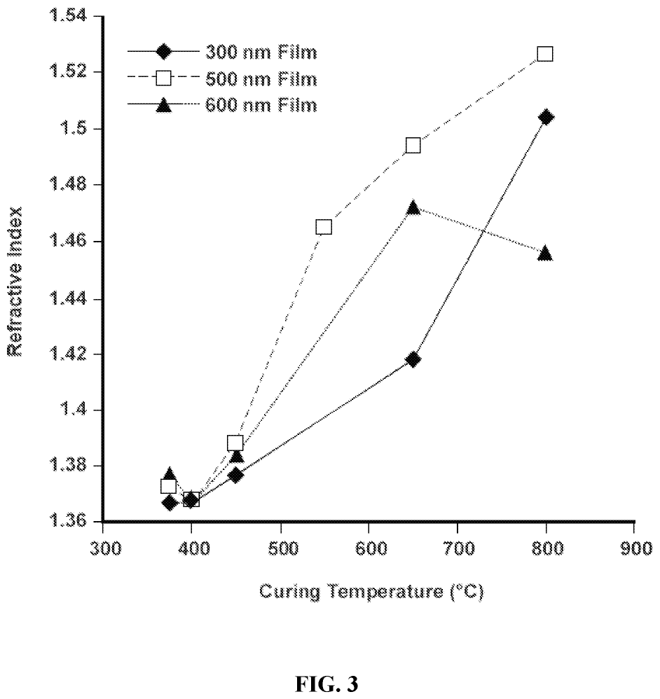

In embodiments, the curing conditions during step 104 can be selected to provide a cured anti-reflective coating 22 having a desired refractive index. For example, some silsesquioxane materials of the present disclosure are characterized by a refractive index that varies as a function of curing temperature. FIG. 3 illustrates plots of example HSQ films showing the relationship between refractive index (as measured at 550 nm) and curing temperature at three different film thicknesses (300 nm, 500 nm, and 800 nm). As can be seen in FIG. 3, generally speaking, as the curing temperature increases, the refractive index of the cured HSQ film also increases. In some examples, the relationship between refractive index, curing temperature, and cured film thickness for a particular silsesquioxane material according to the present disclosure can be determined and the information can be used to select the curing conditions at step 104 to provide a cured anti-reflective coating 22 having the desired thickness and optical properties.

Step 104 may also include plasma treatment to the outer surface of the anti-reflective coating 22 prior to application of the polymeric and/or fluorinated material.

Silsesquioxane films (e.g., hydrogen silsesquioxane (HSQ)) are useful as a primer coating to improve durability of oleophobic/hydrophobic (e.g., ETC) coatings. As provided herein, ion permeability of the deposited silsesquioxane coating in step 104 may be controlled. Amorphous SiO₂ films block ion migration and cannot be present during an ion exchange process if the intent is to build compressive strength. SiOₓ films derived from cured HSQ may similarly block ion migration.

Here, air or O₂ plasma treatment (or others, such as N₂ or argon) of the deposited silsesquioxane coating may be conducted to adjust the ion permeation. While in many instances, blocking ion migration is useful to improve chemical durability, ion migration through the film is advantageous in other situations, such as for anti-microbial glass and glass strengthening through chemical tempering (ion exchange). Here, plasma treatment (or other oxidative methods) renders metal oxide films ion permeable to create defect sites in the coating to enable ion permeation (room temperature or elevated, IOX temperatures), while still not impacting the intended use of the coating itself. Plasma conditions, such as power, may determine the depth of the deposited silsesquioxane coating rendered permeable. If the power is too low, a through path for ions to permeate from the glass to the film surface is not sufficiently created.

Table 1 illustrates examples where HSQ films applied upon Antimicrobial Gorilla Glass® (AMGG) substrates and treated with plasma show log 5 kill with antimicrobial testing (Japanese Industrial Standard Z2801).

TABLE 1

| Sample | HSQ concentration/condition | Log Kill (Avg.) | Log Kill (Std. Dev.) |
|---|---|---|---|
| 1 | AMGG with HSQ (60 nm with plasma) | 5.3 | 0.04 |
| 2 | AMGG wiht HSQ (60 nm no plasma) | 1.33 | 0.13 |
| 3 | AMGG with HSQ (150 nm with plasma) | 5.53 | 0 |
| 4 | AMGG with HSQ (150 nm no plasma) | 1.34 | 0.01 |
| 5 | AMGG | >5 | 0 |

AMGG coated with different thicknesses of HSQ film form amorphous SiOₓ with 20% porosity (cured at 400° C.), before plasma treatment (Samples 2 and 4), show ˜log 1 kill for bacteria (AMGG glass without coating showed log 5 kill, Sample 5), demonstrating a low degree of ion permeability. After plasma treatment, the same substrate shows log 5 kill for bacteria (Samples 1 and 3), which indicates that Ag⁺ from AMGG glass migrates from the AMGG glass surface/cured HSQ film interface, through the HSQ layer to the surface of the coating. Thus, as explained above, the plasma treatment allows the metal Ag⁺ to migrate through the HSQ film, creating defect sites in the HSQ coating. This is advantageous for anti-microbial glass and glass strengthening through chemical tempering (ion exchange).

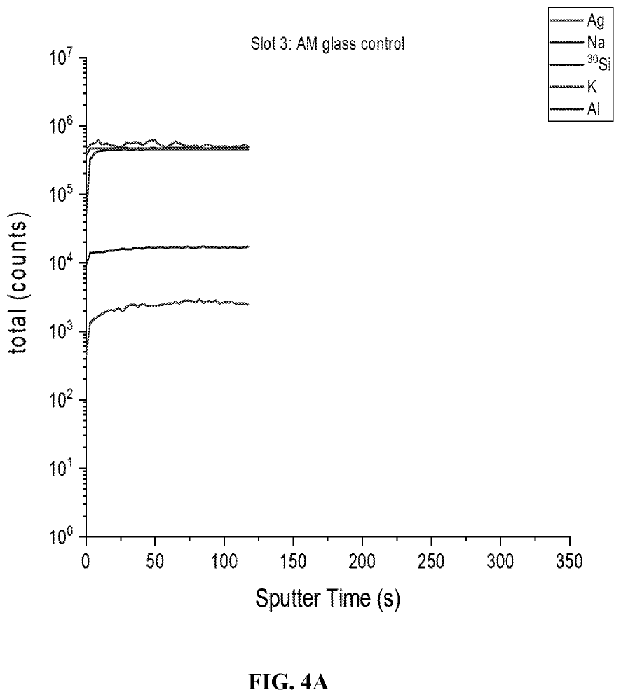

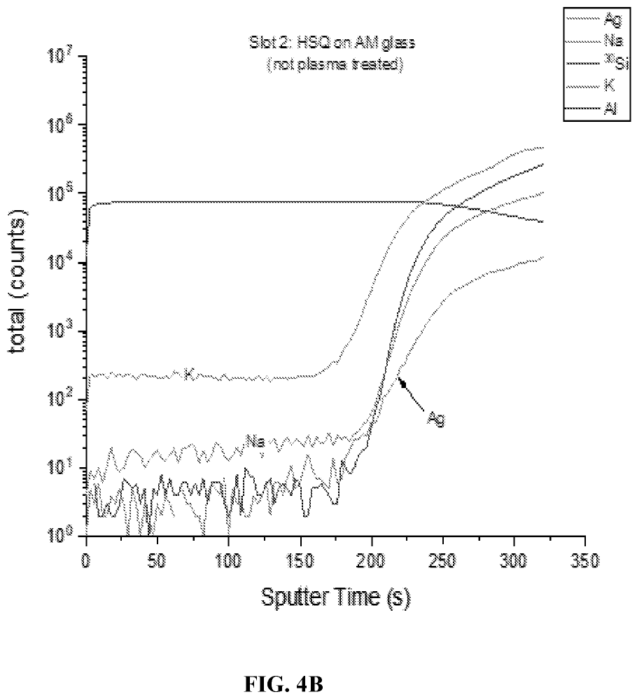

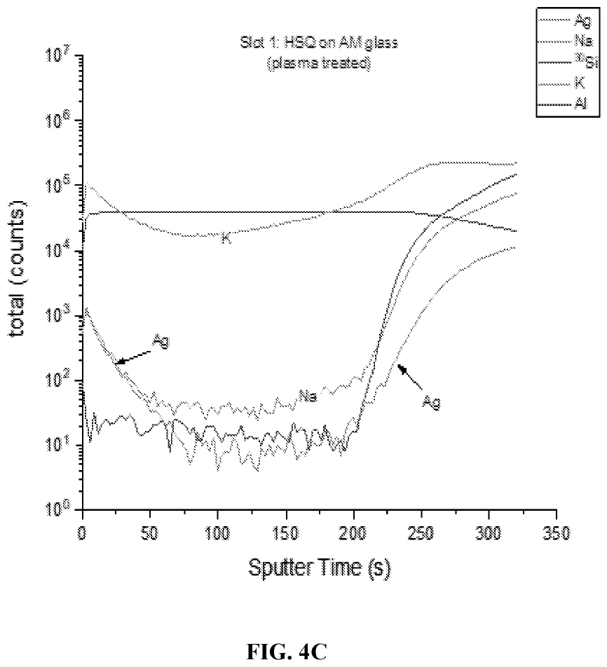

FIGS. 4A-4C are time-of-flight secondary-ion mass spectrometry (ToF-SIMS) depth profiles of AMGG samples without a HSQ coating (FIG. 4A), AMGG samples with a non-plasma-treated HSQ coating (FIG. 4B), and AMGG samples with a plasma-treated HSQ coating (FIG. 4C). ToF-SIMS depth profiles are measured on an IONTOF-M6 ToF-SIMS system. Sputtering is performed with a Gas-Cluster Ion Beam (GCIB) system using O₂ at cluster sizes of ˜800 molecules/cluster at 10 kV impact energy. Sputter beam current is ˜4 nA with a rastered size of 300×300 μm. The analysis beam is Bi⁺ at 30 kV energy with a 100×100 μm sampled area. The mass resolving power of the system is ˜10,000 (m/Δm), sufficient to resolve potential molecular interferences at the masses of the Ag isotopes and other species of interest.

As a baseline, FIG. 4A illustrates a surface Ag-ion SIMS-signal in AMGG glass to be greater than 103. FIG. 4B shows that with an HSQ coating (but without plasma treatment), the Ag signal is about 100 times lower at the coating surface, indicating that a low amount of Ag ions were able to migrate through the HSQ film from the bare AMGG glass surface. FIG. 4C, in contrast, shows that after plasma treatment, the SIMS-signal at the HSQ coating surface is nearly as high as the surface of the bare AMGG, meaning that, as is consistent with the results in Table 1, the plasma treatment allows the metal Ag⁺ to migrate through the HSQ film through internally-created defects.

Thus, while silsesquioxane films (e.g., hydrogen silsesquioxane (HSQ)) may be useful as primer coatings to improve durability of oleophobic/hydrophobic (e.g., ETC) coatings, plasma treatment prior to application of the polymeric and/or fluorinated ETC material may help control and/or modulate ion permeability through the deposited silsesquioxane coating, which is important for anti-microbial and glass strengthening applications.

Thereafter, the method 100 can optionally include a step 106 in which a polymeric and/or fluorinated material suitable for forming the ETC coating 40 can be formed on the anti-reflective coating 22. The polymeric and/or fluorinated material can be any of the materials described above for forming the ETC coating 40. The polymeric and/or fluorinated material can be deposited in any suitable manner, examples of which include spin-coating, spraying, etc. The polymeric and/or fluorinated material can be deposited at step 106 and the article can be heated to cure the polymeric and/or fluorinated material to form the ETC coating 40. The curing at step 106 can include heating the article at a time and temperature suitable for curing the deposited polymeric and/or fluorinated material to form the ETC coating 40. For example, a perfluoropolyether (PFPE) solution can be spray coated onto the anti-reflective coating 22 and cured at about 150° C. to form the ETC coating 40.

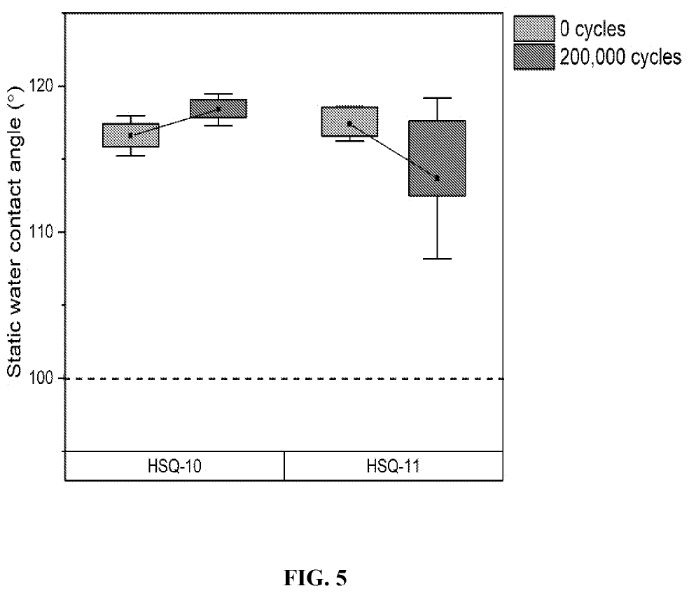

FIG. 5 is data from an AGS Standard cheesecloth abrasion test for AMGG samples with a plasma-treated HSQ coating and the ETC coating. Samples (in duplicate) all maintain a water contact angle greater than 100° after 200,000 cycles of the cheese cloth abrasion test. This illustrates that utilizing plasma is viable for creating ion permeable silsesquioxane (e.g., HSQ) layers while maintaining its initial functionality as an improvement for ETC abrasion durability. In other words, durability and ion permeability may be dual, optimizable, properties of silsesquioxane layers for ETC coating applications.

The embodiments of the present disclosure provide materials and methods for forming anti-reflective coatings using silsesquioxane materials. The silsesquioxane materials described herein can form anti-reflective coatings having optical properties, such as refractive index and reflectance properties, which are suitable for use in many applications, including for use in displays and infrared camera applications. The silsesquioxane materials described herein can be used to form anti-reflective coatings using non-vacuum, liquid-based processing techniques, which can provide cost benefits in manufacturing and potentially expand the use of anti-reflective coatings in other applications. The silsesquioxane materials described herein also provide for the ability to adjust the refractive index of the anti-reflective coating based on curing conditions, such as curing temperature, thickness, type of silsesquioxane materials (e.g., based on R group identity), and/or through the use of pore formers (e.g., as additives and/or as components of the silsesquioxane material). The anti-reflective coatings of the present disclosure also exhibit durability, as measured using the Steel Wool Abrasion Test described above, when used in combination with an ETC coating that is sufficient for many applications, such as displays.

Thus, as presented herein, this disclosure relates to oxide coatings with adjustable ion-permeation as optical and protective coatings. Specifically, silsesquioxane (e.g., HSQ) or other solution processable inorganic oxide films are modified for variable ion permeability using plasma treatment or oxidation.

Advantages include: (1) control of silsesquioxane or other solution processable inorganic oxide film permeability from ion-blocking to ion-permeable using plasma treatment; (2) use of plasma treatment to enable ion exchange through an anti-reflective (AR) coating for glass chemical strengthening; and (3) with Corning Antimicrobial Gorilla Glass®, plasma allows for Ag⁺ transfer through the film, thereby maintaining the antimicrobial effects of the glass and adding a single-layer AR coating for durability.

Many variations and modifications may be made to the above-described embodiments of the disclosure without departing substantially from the spirit and various principles of the disclosure. All such modifications and variations are intended to be included herein within the scope of this disclosure and protected by the following claims.

To the extent not already described, the different features of the various aspects of the present disclosure may be used in combination with each other as desired. That a particular feature is not explicitly illustrated or described with respect to each aspect of the present disclosure is not meant to be construed that it cannot be, but it is done for the sake of brevity and conciseness of the description. Thus, the various features of the different aspects may be mixed and matched as desired to form new aspects, whether or not the new aspects are expressly disclosed.

1. A method of manufacturing an article, comprising:
depositing a solution on a glass, glass-ceramic, or ceramic substrate, the solution comprising a polyhedral oligomeric silsesquioxane having the formula (RSiO_{3/2})ₙ, where R is a hydrogen or an organic moiety;
curing the solution to form an anti-reflective coating; and
plasma treating the anti-reflective coating to form defects in the anti-reflective coating.

2. The method of claim 1, wherein the curing comprises one of thermal curing or electron-beam curing.

3. The method of claim 2, wherein the curing comprises thermally curing the solution at a temperature of from about 400° C. to about 800° C.

4. The method of claim 1, wherein the solution comprises a primary, secondary, or tertiary amine base catalyst.

5. The method of claim 4, wherein the catalyst comprises at least one of hexylamine, aminopropyl trialkoxysilane, alkylamines, acetone oxime, cyclohexylamine, or combinations thereof.

6. The method of claim 1, wherein the curing comprises thermally curing the solution at a temperature of from about 80° C. to about 250° C.

7. The method of claim 1, wherein the solution comprises from about 0.2 wt. % to about 15 wt. % of the polyhedral oligomeric silsesquioxane.

8. The method of claim 1, further comprising:
depositing an easy-to-clean (ETC) coating over the anti-reflective coating, the ETC coating comprising a fluorinated material and a thickness from 1 nm to 20 nm.

9. The method of claim 8, wherein the ETC coating comprises an average contact angle with water of at least about 100 degrees after being subjected to 200,000 cycles of a cheese cloth abrasion test.

10. The method of claim 1, wherein the anti-reflective coating has a thickness from about 10 nm to about 150 nm.

11. The method of claim 1, wherein the plasma-treated anti-reflective coating exhibits at least a bacterial log 3 (avg.) kill as measured by Japanese Industrial Standard Z2801.

12. The method of claim 1, wherein the plasma treating comprises an air plasma treatment or an O₂ plasma treatment.

13. The method of claim 1, wherein the glass, glass-ceramic, or ceramic substrate comprises Ag⁺ ions.

14. An article, comprising:
a glass, glass-ceramic, or ceramic substrate comprising a primary surface;
a plasma-treated anti-reflective coating disposed over the primary surface that comprises at least one layer, the at least one layer comprising a polyhedral oligomeric silsesquioxane having the formula (RSiO_{3/2})ₙ, where R is a hydrogen or an organic moiety; and
an easy-to-clean (ETC) coating disposed over the plasma-treated anti-reflective coating, the ETC coating comprising a fluorinated material and a physical thickness from about 1 nm to about 20 nm.

15. The article of claim 14, wherein the ETC coating comprises an average contact angle with water of at least about 100 degrees after being subjected to 200,000 cycles of a cheese cloth abrasion test.

16. The article of claim 14, wherein the physical thickness of the plasma-treated anti-reflective coating is from about 10 nm to about 150 nm.

17. The article of claim 14, wherein the plasma-treated anti-reflective coating exhibits at least a bacterial log 3 (avg.) kill as measured by Japanese Industrial Standard Z2801.

18. The article of claim 14, wherein the glass, glass-ceramic, or ceramic substrate comprises Ag⁺ ions.
